(19) United States
(12) Patent Application Publication
(10) Pub. No.: US 2024/0354689 A1
(43) Pub. Date: Oct. 24, 2024

(54) COOPERATIVE DELIVERY ASSISTANCE APPARATUS, COOPERATIVE DELIVERY ASSISTANCE METHOD, AND NON-TRANSITORY STORAGE MEDIUM

(71) Applicant: NEC Corporation, Minato-ku, Tokyo (JP)

(72) Inventors: Hiromi MUTO, Tokyo (JP); Yosuke UMEDA, Tokyo (JP); Shiori WATANABE, Tokyo (JP); Daisuke KAWASAKI, Tokyo (JP); Kaori YAMANE, Tokyo (JP)

(73) Assignee: NEC Corporation, Minato-ku, Tokyo (JP)

(21) Appl. No.: 18/580,743

(22) PCT Filed: Jul. 26, 2021
(86) PCT No.: PCT/JP2021/027460

§ 371 Date: Jan. 19, 2024

(51) Int. Cl. G06Q 10/083

(52) U.S. Cl. CPC G06Q 10/083

(57) ABSTRACT

A cooperative delivery assistance system (100) includes a terminal apparatus (101) utilized by a shipper, and a cooperative delivery assistance apparatus (102). The cooperative delivery assistance apparatus (102) includes a delivery condition acquisition unit (106) that acquires a delivery condition of a first package from a first shipper, a candidate extraction unit (110) that extracts, as a candidate package, a candidate of a package to be delivered cooperatively with the first package, from among packages of another shipper, by using the acquired delivery condition, and a display control unit (115) that transmits information for displaying the extracted candidate package in a selectable way.

### TECHNICAL FIELD

The present invention relates to a cooperative delivery assistance apparatus, a cooperative delivery assistance method, and a program.

### BACKGROUND ART

Cooperative delivery refers to loading and delivering packages of different shippers on the same truck. While truck transportation plays an important role in logistics, utilization of cooperative delivery is expected, in order to respond to enhancement of transportation efficiency, environmental improvement such as emission reduction of CO2, response to driver shortage expected in a future, and the like.

For example, Patent Document 1 describes a cooperative delivery information management system for, when shipping orders are received from a plurality of shippers, formulating an optimal transport plan according to shipping order information, and executing transport arrangement for an ordered package according to the transport plan. The cooperative delivery information management system connects, by a computer network, a shipping base terminal provided at a shipping base, a delivery base terminal provided at a delivery base, and the like to a cooperative delivery server provided in an order receiving center that instructs on transport arrangement of the ordered package, in such a way as to permit the terminals to receive data from each other.

When shipping order information is input, the cooperative delivery server generates, based on the shipping order information, shipping instruction data including shipping source information, destination information, and package information, and stores the generated shipping instruction data in a shipping instruction information database. Then, at execution of transport arrangement, the cooperative delivery server determines a shipping base and a delivery base that fit to the shipping instruction data, and distributes the determined shipping instruction data to a shipping base terminal and a delivery base terminal that are associated with the shipping base and the delivery base.

When receiving the shipping instruction data, the shipping base terminal and the delivery base terminal each generate delivery plan data for combining packages of different shippers.

### RELATED DOCUMENT

### Patent Document

Patent Document 1: Japanese Patent Application Publication No. 2005-75634

### DISCLOSURE OF THE INVENTION

### Technical Problem

With a technique described in Cited Document 1, there is a possibility of being delivered cooperatively with a package of another shipper that a shipper does not desire. Moreover, with the technique of Cited Document 1, when there are a plurality of candidates of packages of another shipper to be delivered cooperatively with the a package of a shipper, the package of the shipper is not necessarily delivered cooperatively with a package of another shipper being most desirable for the shipper.

The present invention has been made in view of the circumstances described above, and one of objects thereof is to enable cooperative delivery of a package being desirable for a shipper.

### Solution to Problem

In order to achieve the above object, a cooperative delivery assistance apparatus according to a first aspect of the present invention includes:
a delivery condition acquisition unit that acquires a delivery condition of a first package from a first shipper;
a candidate extraction unit that extracts, as a candidate package, a candidate of a package to be delivered cooperatively with the first package, from among packages of another shipper, by using the acquired delivery condition; and
a display control unit that transmits information for displaying the extracted candidate package in a selectable way.

A cooperative delivery assistance system according to a second aspect of the present invention includes:
a delivery condition acquisition unit that acquires a delivery condition of a first package from a first shipper;
a candidate extraction unit that extracts, as a candidate package, a candidate of a package to be delivered cooperatively with the first package, from among packages of another shipper, by using the acquired delivery condition; and
a display unit that displays the extracted candidate package in a selectable way.

A terminal apparatus according to a third aspect of the present invention includes:
an input unit that accepts input of a delivery condition of a first package from a first shipper;
a communication unit that acquires a candidate package acquired by extracting, as the candidate package, a candidate of a package to be delivered cooperatively with the first package, from among packages of another shipper, by using the accepted delivery condition; and
a display unit that displays the acquired candidate package in a selectable way.

A cooperative delivery assistance method according to a fourth aspect of the present invention includes,
by a computer:
acquiring a delivery condition of a first package from a first shipper;
extracting, as a candidate package, a candidate of a package to be delivered cooperatively with the first package, from among packages of another shipper, by using the acquired delivery condition; and
transmitting information for displaying the extracted candidate package in a selectable way.

A program according to a fifth aspect of the present invention causes a computer to execute:
acquiring a delivery condition of a first package from a first shipper;
extracting, as a candidate package, a candidate of a package to be delivered cooperatively with the first package, from among packages of another shipper, by using the acquired delivery condition; and
transmitting information for displaying the extracted candidate package in a selectable way.

### Advantageous Effects of Invention

The present invention enables cooperative delivery of a package being desirable for a shipper.

### BRIEF DESCRIPTION OF THE DRAWINGS

FIG. 1 is a diagram illustrating an example of a configuration of a cooperative delivery assistance system according to one example embodiment of the present invention.

FIG. 2 is a diagram illustrating a functional configuration of a terminal apparatus according to one example embodiment.

FIG. 3 is a diagram illustrating one example of delivery information according to one example embodiment, (a) illustrates an overall configuration of delivery information, (b) illustrates a configuration of delivery area information included in the delivery information, and (c) illustrates a configuration of delivery time information included in the delivery information.

FIG. 4 is a diagram illustrating one example of shipper information according to one example embodiment.

FIG. 5 is a diagram illustrating one example of transporter information according to one example embodiment.

FIG. 6 is a diagram illustrating one example of a hierarchical structure determined regarding an area according to one example embodiment.

FIG. 7 is a diagram illustrating an example of a physical configuration of a terminal apparatus according to one example embodiment.

FIG. 8 is a diagram illustrating an example of a physical configuration of the cooperative delivery assistance apparatus according to one example embodiment.

FIG. 9 is a diagram illustrating one example of a flow of cooperative delivery assistance processing.

FIG. 10 is a diagram illustrating one example of the flow of the cooperative delivery assistance processing.

FIG. 11 is a diagram illustrating one example of the flow of the cooperative delivery assistance processing.

FIG. 12 is a flowchart illustrating one example of delivery condition input processing.

FIG. 13 is a diagram illustrating one example of an input screen SC1 for inputting a delivery area relating to a first package.

FIG. 14 is a diagram illustrating one example of an input screen SC2 for inputting a delivery time relating to the first package.

FIG. 15 is a diagram illustrating one example of an input screen SC3 for inputting package property information and fare information relating to a first package.

FIG. 16 is a diagram illustrating one example of an input screen SC4 for inputting fluctuation information and vehicle property information relating to the first package.

FIG. 17 is a diagram illustrating another example of a hierarchical structure determined for an area.

### DESCRIPTION OF EMBODIMENTS

Hereinafter, an example embodiment according to the present invention is described by use of the drawings. Note that, in all of the drawings, a similar component is assigned with a similar reference sign, and description thereof is omitted as appropriate.

### Configuration of Cooperative Delivery Assistance System 100

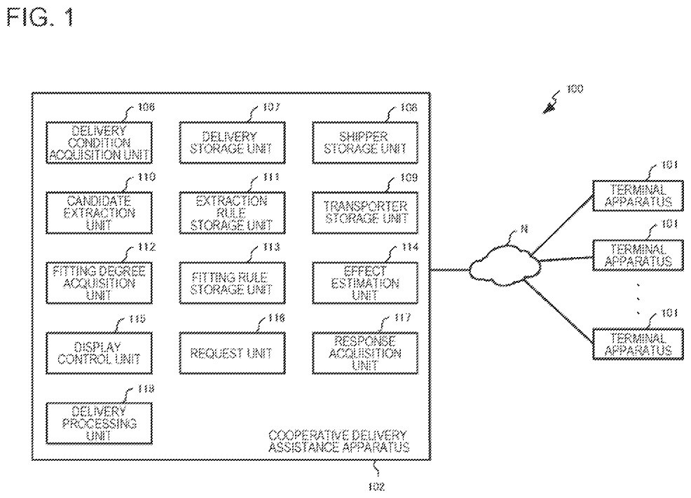

The cooperative delivery assistance system 100 is a system for assisting cooperative delivery in which packages of different shippers are loaded and 20 delivered on the same truck (i.e., a freight car). The cooperative delivery assistance system 100 includes, as illustrated in FIG. 1, a plurality of terminal apparatuses 101 for each of shippers to operate, and a cooperative delivery assistance apparatus 102 for managing the plurality of terminal apparatuses 101.

Each of the plurality of terminal apparatuses 101 and the cooperative delivery assistance apparatus 102 are communicably connected to each other via a network N, as illustrated in FIG. 1. The network N includes a wide area network (WAN) such as the Internet, a local area network (LAN), and the like, and is constructed wiredly, wirelessly, or by a combination thereof.

Note that, at least one terminal apparatus 101 may be provided.

### (Functional Configuration of Terminal Apparatus 101)

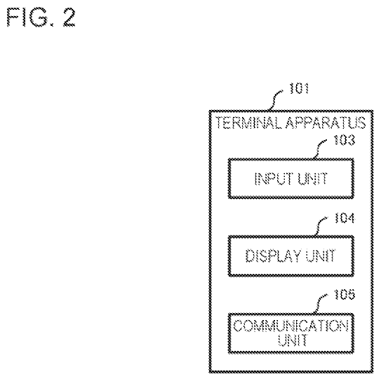

Each of the terminal apparatuses 101 is an apparatus utilized by a shipper, and is typically installed in an office of a company or an individual being a shipper. Each of the terminal apparatuses 101 functionally includes an input unit 103, a display unit 104, and a communication unit 105, as illustrated in FIG. 2.

The input unit 103 accepts information input by a shipper. The display unit 104 displays information to the shipper.

The communication unit 105 mutually transmits and receives various types of information with the cooperative delivery assistance apparatus 102 via the network N. Note that, the communication unit 105 may mutually transmit and receive various types of information via the network N among the plurality of terminal apparatuses 101.

### (Functional Configuration of Cooperative Delivery Assistance Apparatus 102)

Functionally, as illustrated in FIG. 1, the cooperative delivery assistance apparatus 102 includes a delivery condition acquisition unit 106, a delivery storage unit 107, a shipper storage unit 108, a transporter storage unit 109, a candidate extraction unit 110, an extraction rule storage unit 111, a fitting degree acquisition unit 112, a fitting rule storage unit 113, an effect estimation unit 114, a display control unit 115, a request unit 116, a response acquisition unit 117, and a delivery processing unit 118.

The delivery condition acquisition unit 106 acquires a delivery condition of a first package from a first shipper. The first shipper is a shipper who wishes for cooperative delivery with a package of another shipper. The first package is a package of the first shipper. The delivery condition is a condition relating to delivery of the package and is determined according to a request of a shipper. Details of the delivery condition are described later.

The delivery storage unit 107 is a storage unit for storing delivery information 107a relating to an already determined package scheduled to be delivered. The delivery information 107a is previously stored in the delivery storage unit 107.

In general, for delivery of a package, there are regular delivery that is regularly performed, individual delivery that is performed on a specific date and time, and the like. The regular delivery is, for example, a delivery repeatedly performed in a previously determined time or time period every day, on a previously determined day of a week, or on a previously determined date of a month, through a specific route, regarding a package of a specific shipper. In the regular delivery, the same type of package is normally delivered on each delivery. The individual delivery is delivery performed on a specific date and time (a specific day, and a specific time or time period) for a specific shipper and a package.

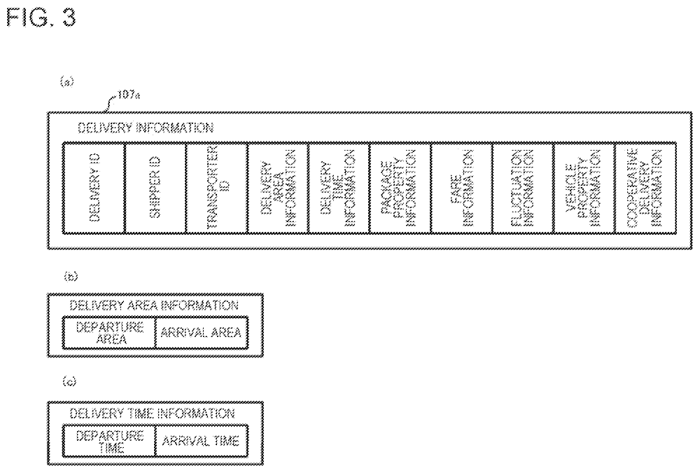

FIG. 3 is a diagram illustrating one example of the configuration of the delivery information 107a. As illustrated in FIG. 3(a), the delivery information 107a is information associating a delivery identifier (ID), a shipper ID, a transporter ID, delivery area information, delivery time information, package property information, fare information, fluctuation information, vehicle property information, and cooperative delivery information.

Herein, the delivery area information, the delivery time information, the package property information, the fare information, the fluctuation information, and the vehicle property information are pieces of information included in the delivery condition. That is to say, the pieces of information included in the delivery information 107a are delivery conditions of a package to be delivered.

The delivery ID is information for identifying a package related to delivery such as regular delivery and individual delivery.

A delivery ID of regular delivery is assigned to each regular delivery. Since the same type of package is normally delivered on each delivery in regular delivery as described above, the package to be delivered by the regular delivery can be identified by the delivery ID of the regular delivery. A delivery ID of individual delivery is assigned to each individual delivery. Since a package to be delivered is determined in the individual delivery, the package to be delivered by the individual delivery can also be identified by the delivery ID of the individual delivery.

Note that, the present example embodiment is described with an example in which a delivery ID of regular delivery is assigned to each regular delivery, but a delivery ID may be assigned to each individual delivery performed as regular delivery.

The shipper ID is information for identifying a shipper of a package related to a delivery ID being associated with the shipper ID.

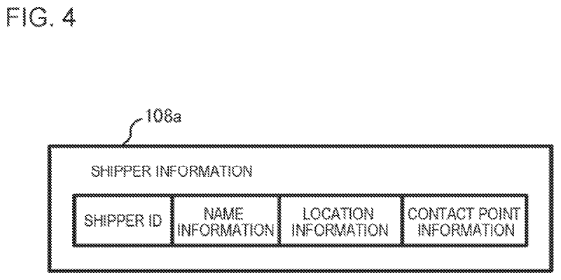

Herein, the shipper storage unit 108 is a storage unit for storing shipper information 108a relating to a shipper, and one example of the configuration of the shipper information 108a is illustrated in FIG. 4. As illustrated in FIG. 4, the shipper information 108a is information associating a shipper ID, name information, location information, and contact point information.

The shipper ID of the shipper information 108a is information for identifying a shipper of a package, similarly to the shipper ID of the delivery information 107a. The shipper ID associates the delivery information 107a with the shipper information 108a.

The name information, the location information, and the contact point information of the shipper information 108a are pieces of information indicating a name, a location (e.g., an address), and a contact point of the shipper identified by a shipper ID being associated with the pieces of information. The contact point is an address for contacting a shipper, for example, an e-mail address. Note that, a contact point indicated by the contact point information of the shipper information 108a may be an address of a shipper determined by the cooperative delivery assistance system 100.

FIG. 3 is referred to again.

The transporter ID is information for identifying a company, an individual, or the like being a deliverer of a package related to a delivery ID being associated with the transporter ID.

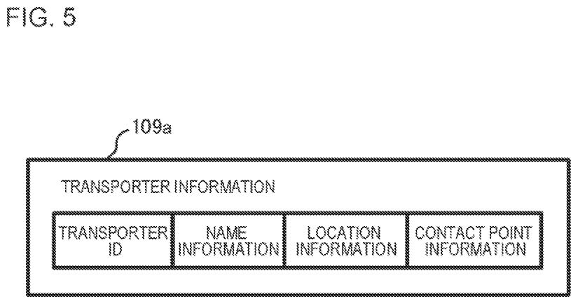

Herein, the transporter storage unit 109 is a storage unit for storing transporter information 109a relating to a shipper, and one example of a configuration of the transporter information 109a is illustrated in FIG. 5. As illustrated in FIG. 5, the transporter information 109a is information associating a transporter ID, name information, location information, and contact point information.

The transporter ID of the transporter information 109a is information for identifying a transporter of a package, similarly to the transporter ID of the delivery information 107a. The transporter ID associates the delivery information 107a with the transporter information 109a.

The name information, the location information, and the contact point information of the transporter information 109a are pieces of information indicating a name, a location (e.g., an address), and a contact point of the transporter identified by the transporter ID being associated with the pieces of information. The contact point is an address for contacting a transporter, for example, an e-mail address. Note that, the contact point indicated by the contact point information of the transporter information 109a may be an address of a transporter determined by the cooperative delivery assistance system 100.

FIG. 3 is referred to again.

The delivery area information is information indicating a delivery area of a package related to a delivery ID being associated with the delivery area information. Specifically, as illustrated in FIG. 3(b), the delivery area information includes a departure area relating to an area of loading a package related to a delivery ID being associated with the delivery area information, and an arrival area relating to an area of unloading the package.

The departure area is information for identifying an area where a departure point of a package is located, i.e., typically an area where a point of loading a package onto a truck is located. The arrival area is information for identifying an area where a destination of a package is located, i.e., typically an area where a point of unloading a package from a truck is located.

The area may be, for example, each municipality in Japan, one or a plurality of municipalities previously grouped, or the like, but, in the present example embodiment, the area is previously stipulated with a hierarchical structure.

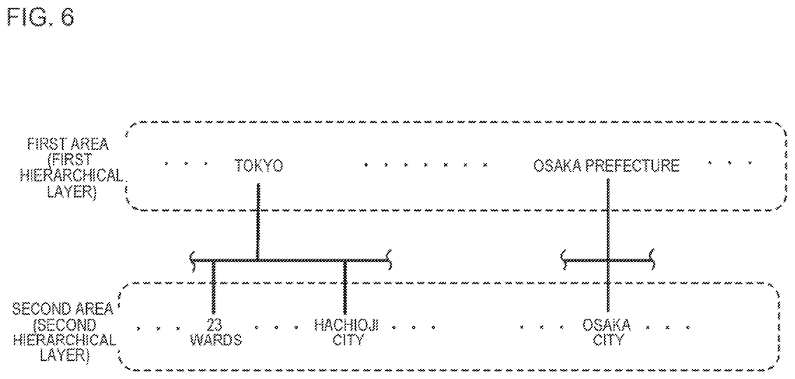

FIG. 6 is a diagram illustrating one example of a hierarchical structure of an area according to the present example embodiment. As illustrated in FIG. 6, the hierarchical structure according to the present example embodiment is a two-layered structure, and each prefecture is set for a first area belonging to a first layer of a high order. An area being associated with one or a plurality of previously determined municipalities is set for a second area belonging to a second layer of a low order.

Then, a second area geographically included in the first area belongs to a low order of the first area. For example, in the hierarchical structure illustrated in FIG. 6, when Tokyo being one of the first areas is looked at, 23 wards, Hachioji City, and the like included in Tokyo belong to a low order of Tokyo as second areas. It is assumed that “23 wards” indicate an area where so-called 23 wards (i.e., a plurality of wards) such as Minato Ward, Chiyoda Ward, and Shinagawa Ward included in Tokyo are put together.

Each of the departure area and the arrival area according to the present example embodiment includes area information for identifying areas belonging to each layer. For example, when a departure point is located in Minato Ward, Tokyo, a departure area includes “Tokyo” as area information for identifying the first area and “23 wards” as area information for identifying the second area. Moreover, for example, when an arrival point is located in Osaka City, Osaka Prefecture, the arrival area includes “Osaka Prefecture” as area information for identifying the first area, and “Osaka City” as area information for identifying the second area.

FIG. 3 is referred to again.

The delivery time information is information indicating a delivery time of a package relating to a delivery ID being associated with the delivery time information. Specifically, the delivery time information includes a departure time and an arrival time of a package related to a delivery ID being associated with the delivery time information, as illustrated in FIG. 3(c).

The departure time is information for determining a departure date and time of a package, i.e., a scheduled date and a scheduled time of loading a package onto a truck. The arrival time is information for determining an arrival date and time of a package, i.e., a scheduled date and a scheduled time of unloading a package from a truck.

Information for determining a scheduled date included in a departure time and an arrival time is, in a case of regular delivery, information for determining a period and a date in the period, and indicates, for example, every day, a day of a week, or a day of a month. Information for determining a scheduled date in a case of individual delivery indicates a specific date and time.

Information for determining a scheduled time included in the departure time and the arrival time includes, for example, a time period such as times between ∘∘ and ΔΔ, and further includes a changeable time period (allowable time), when a change of the time period is permitted. Note that, information for determining a scheduled time may be represented by a specific time.

The package property information is information indicating a property of a package, and includes, for example, at least one of an article, whether mixed loading is permitted, a temperature range, a packing style, and an average shipping amount per shipping and a freight property.

The article is information indicating a type of package, such as food, information equipment, automotive parts, cosmetics, or a drug.

Whether mixed loading is permitted is information indicating whether mixed loading with another package is permitted, and is typically determined according to a request of a shipper. For example, whether mixed loading is permitted includes “mixed loading permitted” that permits mixed loading, “same industry not permitted” that does not permit mixed loading with the same industry, “different industry not permitted” that does not permit loading with a different industry, and the like.

Note that, whether mixed loading is permitted may be set according to a rule previously determined by a transporter according to at least one of the another item (e.g., an article, a temperature range, or a packing style) of the package property information.

The temperature range is information indicating a temperature range when a package is transported, and is typically determined according to a request of a shipper.

The packing style is information indicating an aspect when a package is loaded on a truck, for example, individual, a case, a cart, a pallet, or the like. Individual indicates that a package is individually loaded onto a truck. A case, a cart, and a pallet indicate that a package is accommodated in a case, a cart (a cart with a crate), and a pallet, respectively, and loaded onto a truck.

The average shipping amount per shipping indicates an average amount of packages. A unit of the average shipping amount is, for example, weight such as a ton or a kilogram, and a volume such as a cubic meter (m3).

The freight property is information indicating a previously determined property regarding a package, such as perishables, refrigerated goods, and dirty/smelly goods.

The fare information is information indicating a fare level to be applied to a shipper. For the fare information, for example, “expensive” is set for a package of a previously determined type, such as a package requiring particularly careful handling, and “normal” is set for package of other types.

Fluctuation information is information indicating a periodic fluctuation in a shipping amount of a package regarding regular delivery, and is set when there is a periodic fluctuation in a shipping amount of a package.

For example, the fluctuation information includes presence and absence of a fluctuation in a previously determined period such as a year, a month, or a week. Moreover, the fluctuation information regarding a package with a fluctuation includes at least one of a degree of the fluctuation, a period when a shipping amount is large, a period when a shipping amount is small, and the like.

It is preferable that presence and absence and a degree of such a fluctuation are set according to a previously determined criterion. For example, in each of cases where a shipping amount is substantially less than ±10%, ±10% or more and less than 25%, and ±25% or more with an average shipping amount as a criterion, it is preferable that “no fluctuation”, “there is a small fluctuation”, and “there is a large fluctuation” are set. 10% and 25% to be criteria for presence and absence and largeness and smallness of a fluctuation exemplified herein are examples, and may be changed as appropriate.

Further, the fluctuation information may include a loading rate according to an average shipping amount.

Vehicle property information is information relating to a property of a truck used for delivery, and is typically determined according to a request of a shipper.

A vehicle size and vehicle equipment can be cited as examples of vehicle property information. The vehicle size is, for example, information indicating a size of a truck such as a two-ton vehicle, a four-ton vehicle, or a ten-ton vehicle. The vehicle equipment is information relating to equipment of a truck, and is, for example, a “power gate (registered trademark)”, a “wing”, a “low pollution vehicle”, or the like.

The power gate (registered trademark) refers to a truck equipped with equipment for raising and lowering a package to and from a loading platform during loading and unloading. The wing refers to a truck that can flip up a side surface of the loading platform. With a wing vehicle, a package can be loaded and unloaded from a lateral side of the loading platform. A low-pollution vehicle refers to a truck of which emission of an air pollutant satisfies a predetermined condition.

The cooperative delivery information is information indicating a delivery ID of a package of another shipper to be cooperatively delivered. That is to say, the cooperative delivery information indicates a delivery ID of delivery related to a package of another shipper to be delivered cooperatively with a package related to delivery identified by a delivery ID associated the cooperative delivery information. The cooperative delivery information is set when a package of another shipper to be targeted for cooperative delivery is decided.

FIG. 1 is referred to again.

The candidate extraction unit 110 extracts a candidate package from among packages of another shipper, by using a delivery condition acquired by the delivery condition acquisition unit 106. The candidate package is a candidate of a package to be delivered cooperatively with the first package.

In the present example embodiment, the candidate extraction unit 110 extracts the delivery information 107a from among pieces of the delivery information 107a of another shipper stored in the delivery storage unit 107, by using a delivery condition and an extraction rule described later. The extraction rule is a previously determined rule for extracting a candidate of a package to be targeted for cooperative delivery.

The extraction rule storage unit 111 is a storage unit for storing an extraction rule. The extraction rule includes, for example, permission of mixed loading of a package.

Note that, the extraction rule is not limited thereto. For example, the extraction rule may include a matter that the first area of one or both of a departure area and an arrival area match between a delivery condition and the delivery information 107a (i.e., a matter that an area of a hierarchal layer of the highest order is common). Further, for example, the extraction rule may include a matter that one or both of a departure time and an arrival time overlap at least in an allowable time between a delivery condition and the delivery information 107a. Further, the extraction rule may include any two or more of the rules according to the embodiment and exemplified herein.

The fitting degree acquisition unit 112 derives a fitting degree between a delivery condition for the first package acquired by the delivery condition acquisition unit 106 and a delivery condition of a candidate package extracted by the candidate extraction unit 110. The delivery condition of the candidate package is acquired from information being associated with a delivery ID related to the candidate package in the delivery information 107a.

Specifically, the fitting degree acquisition unit 112 derives a fitting degree by applying a fitting rule, being a rule for deriving a fitting degree, to a delivery condition of each of the first package and the candidate package.

The fitting rule includes, for example, an item fitting degree previously determined regarding an item or a combination of items included in a delivery condition. The fitting degree acquisition unit 112 derives each of the item fitting degrees by applying the fitting rule to an item or a combination of items of delivery conditions of the first package and the candidate package. The fitting degree acquisition unit 112 derives an overall fitting degree of the delivery conditions of the first package and the candidate package by adding up the item fitting degrees.

The fitting rule storage unit 113 is a storage unit for storing a fitting rule.

The following can be cited as one example of an item fitting degree defined in a fitting rule.

Regarding the delivery area information, a higher item fitting degree is determined as the first package and the candidate package match in an area of a low order. In other words, when an area having a hierarchical structure is determined, a higher item fitting degree is determined as a matching degree of an area indicated by the delivery area information is higher between the first package and the candidate package.

For example, regarding each of the departure area and the arrival area included in the delivery area information, the item fitting degree in a case of no matching is defined as “0”, the item fitting degree in a case where only the first area matches is defined as “1”, and the item fitting degree in a case where the first area and the second area match is defined as “2”.

Regarding the delivery time information, an item fitting degree when a date of a delivery time and an allowable time match between the first package and the candidate package is determined. For example, an item fitting degree in a case where there is a time overlapping a date and an allowable time between the first package and the candidate package is defined as “1”, and an item fitting degree in a case where there is no overlapping time is defined as “0”. Note that, the item priority degree regarding the delivery time information may be determined in such a way as to become higher as an overlapping time is longer in a date and an allowable time included in delivery times of the first package and the candidate package.

Regarding the package property information, the item fitting degree in a case where an article is a previously determined combination between the first package and the candidate package is determined. For example, an item fitting degree in a case where an article of the first package and the candidate package is a combination suitable for cooperative delivery (e.g., miscellaneous goods and food, an automobile part and information equipment) is defined as “1”. Moreover, an item fitting degree in a case where an article of the first package and the candidate package is a combination that is not suitable for cooperative delivery (e.g., an automobile part and food) is defined as “0”.

Moreover, regarding package property information, an item fitting degree is determined according to whether each of a temperature range, a packing style, and a freight property matches between the first package and the candidate package. For example, an item fitting degree in a case where each of a temperature range, a packing style, and a freight property matches between the first package and the candidate package is defined as “1”, and an item fitting degree in a case of being different is defined as “0”.

Further, regarding a combination of an average shipping amount per shipping of package property information and a vehicle size of vehicle property information, an item fitting degree in a case where a difference between a total of average shipping amounts per shipping of the first package and the candidate package and a vehicle size is within a previously determined range is determined is defined as “1”. An item fitting degree in a case where a difference between a total of average shipping amounts per shipping of the first package and the candidate package and a vehicle size is beyond a previously determined range is defined as “0”.

Regarding the fare information, an item fitting degree in a case where fare levels match between the first package and the candidate package is determined. For example, an item fitting degree in a case where a fare level match between the first package and the candidate package is defined as “1”, and an item fitting degree in a case where a fare levels are different is defined as “0”.

Regarding the fluctuation information, an item fitting degree in a case where a period when a shipping amount in each period is large is different between the first package and the candidate package is determined. For example, an item fitting degree in a case where a period when shipping amounts in all periods are large is different between the first package and the candidate package is defined as “1”, and an item fitting degree in a case where a period when a shipping amount in at least one period is large is the same is defined as “0”.

Regarding the vehicle equipment in the vehicle property information, an item fitting degree in a case where vehicle equipment matches between the first package and the candidate package is determined. For example, an item fitting degree in a case where vehicle equipment matches between the first package and the candidate package is defined as “1”, and an item fitting degree in a case where vehicle equipment is different is defined as “0”.

Note that, a fitting rule is not limited thereto, and, for example, the specific value of each of item fitting degrees may be changed as appropriate. Moreover, for example, the fitting rule may define a fitting degree for each combination of all or some of items included in a delivery condition.

The effect estimation unit 114 derives a reduction effect indicating a degree at which a previously determined reduction item can be reduced in a case where the first package and the candidate package are cooperatively delivered as compared to a case where the first package and the candidate package are individually delivered.

In general, performing cooperative delivery has a reduction effect of a fare in delivery, an environmental burden, and the like. The environmental burden is represented by, for example, a carbon dioxide emission amount or the like. The effect estimation unit 114 derives, regarding a previously determined reduction item (a fare, an environmental burden, and the like), estimation values in cases where the first package and the candidate package are individually delivered and cooperatively delivered. Then, the effect estimation unit 114 computes a difference between the estimation values, and thereby derives, as a reduction effect, a reduction amount acquired in the case of cooperatively delivering.

The display control unit 115 transmits display information to the terminal apparatus 101 of the first shipper via the network N. The display information includes, for example, the delivery information 107a of the candidate package and at least one of a fitting degree and a reduction effect regarding the candidate package.

Thereby, the display control unit 115 causes the display unit 104 included in the terminal apparatus 101 of the first shipper to display the display information. In this instance, the display information is displayed in such a way that one of candidate packages can be selected as a target for cooperative delivery on the terminal apparatus 101 of the first shipper. That is to say, the display information is information for causing the terminal apparatus 101 of the first shipper to display a candidate package in a selectable way.

The request unit 116 notifies, of a request for cooperative delivery, a second shipper being a shipper of a second package being a package selected by the first shipper from among the candidate packages displayed on the display unit 104.

Specifically, the request unit 116 acquires second package information from the terminal apparatus 101 of the first shipper. The second package information is information for determining a second package being a package selected by the first shipper from among candidate packages. Then, the request unit 116 transmits a request for cooperative delivery to the second shipper being a shipper of a package determined by the second package information.

The response acquisition unit 117 acquires, from the terminal apparatus 101 of the second shipper, a response to the request notified from the request unit 116. The response includes whether the second shipper approves cooperative delivery of the first package and the second package. Then, the response acquisition unit 117 transmits a content of the acquired response to the terminal apparatus 101 of the first shipper. Thereby, the terminal apparatus 101 of the first shipper is notified of the content of the response from the second shipper.

The delivery processing unit 118 performs cooperative delivery processing when a response acquired by the response acquisition unit 117 is approval, i.e., when approval for the request for cooperative delivery is acquired. The cooperative delivery processing is processing for cooperatively delivering the first package and the second package, and a content thereof may be determined as appropriate.

For example, the cooperative delivery processing includes generating delivery information 107a related to the first package and storing the generating delivery information 107a in the delivery storage unit 107. A delivery ID of the delivery information 107a related to the second package is set for the cooperative delivery information of the delivery information 107a of the first shipper. Moreover, for example, the cooperative delivery processing includes setting the delivery ID of the delivery information 107a related to the first package for the cooperative delivery information of the delivery information 107a of the second package.

Further, for example, cooperative delivery processing includes notifying a deliverer of the second package that the second package is delivered cooperatively with the first package, and the like. In this notification, for example, information including cooperative delivery of the second package with the first package is transmitted to a contact point indicated by contact point information of the transporter information 109a being associated with the transporter ID of the delivery information 107a related to the second package.

### Configuration of Cooperative Delivery Assistance System 100

So far, the functional configuration of the cooperative delivery assistance system 100 has been described. From here, a physical configuration of each of the terminal apparatus 101 and the cooperative delivery assistance apparatus 102 that are communicably connected to each other via the network N is described.

### (Physical Configuration of Terminal Apparatus 101)

The terminal apparatus 101 is physically, for example, a personal computer, a tablet personal computer (PC), a smartphone, or the like.

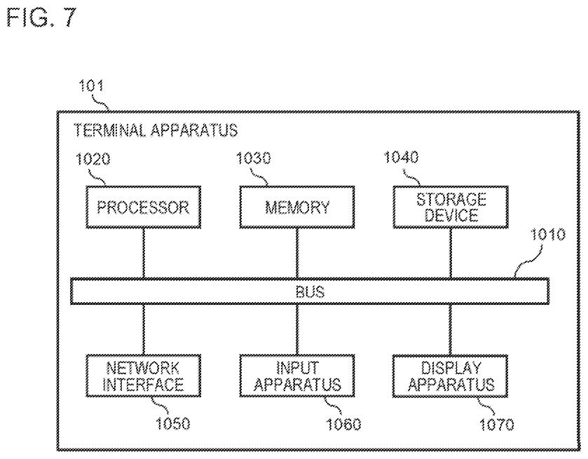

Specifically, for example, the terminal apparatus 101 physically includes, for example, a bus 1010, a processor 1020, a memory 1030, a storage device 1040, a network interface 1050, an input apparatus 1060, and a display apparatus 1070, as illustrated in FIG. 7.

The bus 1010 is a data transmission path through which the processor 1020, the memory 1030, the storage device 1040, the network interface 1050, the input apparatus 1060, and the display apparatus 1070 transmit/receive data to/from each another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 of the terminal apparatus 101 stores a program module for achieving each functional unit of the terminal apparatus 101. The processor 1020 reads each of the program modules onto the memory 1030, executes the read program module, and thereby achieves each functional unit being associated with the program module.

The network interface 1050 is an interface for connecting the terminal apparatus 101 to the network N.

The input apparatus 1060 is an apparatus for a user to input information, for example, a touch panel, a keyboard, a mouse, or the like.

The display apparatus 1070 is an apparatus for presenting information to the user, for example, a liquid crystal panel or the like.

### (Physical Configuration of Cooperative Delivery Assistance Apparatus 102)

The cooperative delivery assistance apparatus 102 is physically, for example, a personal computer or the like.

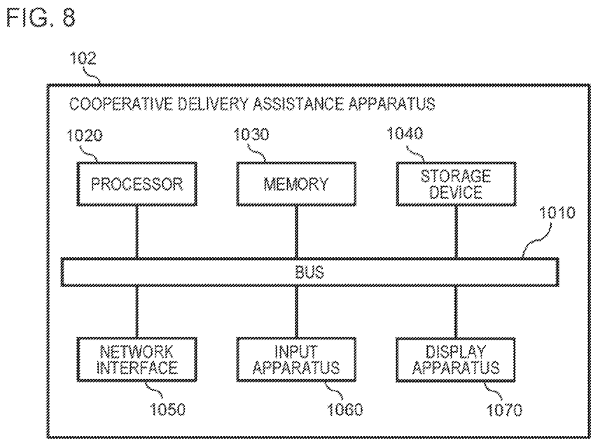

Specifically, for example, the cooperative delivery assistance apparatus 102 physically includes a bus 1010, a processor 1020, a memory 1030, a storage device 1040, a network interface 1050, an input apparatus 1060, and a display apparatus 1070, substantially similar to those of the terminal apparatus 101, as illustrated in FIG. 8.

The storage device 1040 of the cooperative delivery assistance apparatus 102 stores a program module for achieving each functional unit of the cooperative delivery assistance apparatus 102. The processor 1020 reads each of the program modules onto the memory 1030, executes the read program module, and thereby achieves each functional unit being associated with the program module.

### Operation of Cooperative Delivery Assistance System 100

From here, the operation of the cooperative delivery assistance system 100 is described with reference to the drawings.

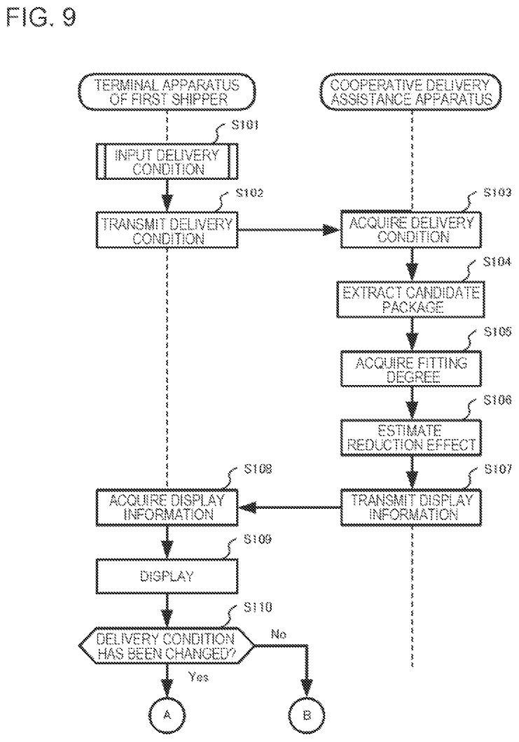

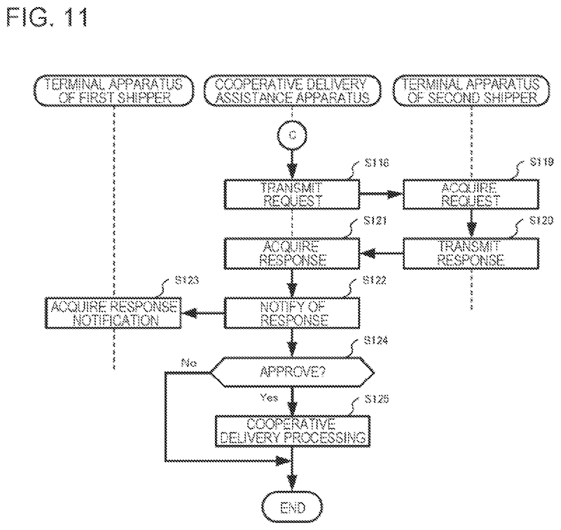

FIGS. 9 to 11 are diagrams illustrating one example of a flow of cooperative delivery assistance processing according to the present example embodiment. The cooperative delivery assistance processing is processing for assisting cooperative delivery. The cooperative delivery assistance processing is performed in a state where a program previously installed in each of the terminal apparatuses 101 and the cooperative delivery assistance apparatuses 102 of the first shipper and the second shipper is executed, and is started by logging in of the first shipper into the terminal apparatus 101.

In login of the first shipper, the cooperative delivery assistance apparatus 102 acquires, for example, a shipper ID and a password input by the first shipper into the terminal apparatus 101 via the network N, and confirms that a combination of the acquired shipper ID and password is the same as a previously registered one.

FIG. 9 is referred to.

The input unit 103 included in the terminal apparatus 101 of the first shipper performs delivery condition input processing (step S101). The delivery condition input processing is processing of accepting input of a delivery condition relating to the first package from the first shipper.

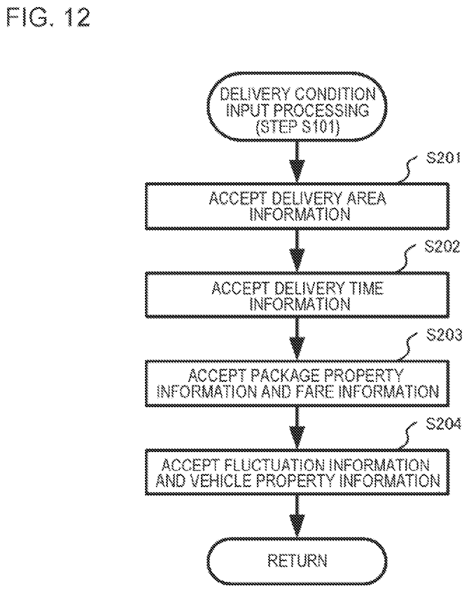

FIG. 12 is a flowchart illustrating one example of the delivery condition input processing.

The input unit 103 included in the terminal apparatus 101 of the first shipper accepts delivery area information relating to the first package according to input of the first shipper (step S201).

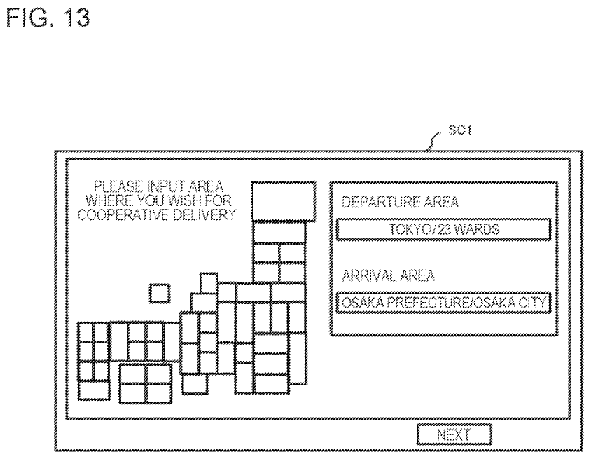

Specifically, for example, the input unit 103 accepts delivery area information of the first package according to a content input to a delivery area input screen SC1 displayed on the display unit 104. FIG. 13 is a diagram illustrating one example of the delivery area input screen SC1.

When a previously determined operation (e.g., pressing of a “next” button illustrated in FIG. 13) is performed, the input unit 103 accepts and holds a departure area and an arrival area input to the delivery area input screen SC1, and executes subsequent processing. In the example illustrated in FIG. 13, “Tokyo” of the first area and “23 wards” of the second area are input as the departure area. Moreover, as the arrival areas, “Osaka Prefecture” of the first area and “Osaka City” of the second area are input.

The input unit 103 included in the terminal apparatus 101 of the first shipper accepts delivery time information relating to the first package according to input of the first shipper (step S202).

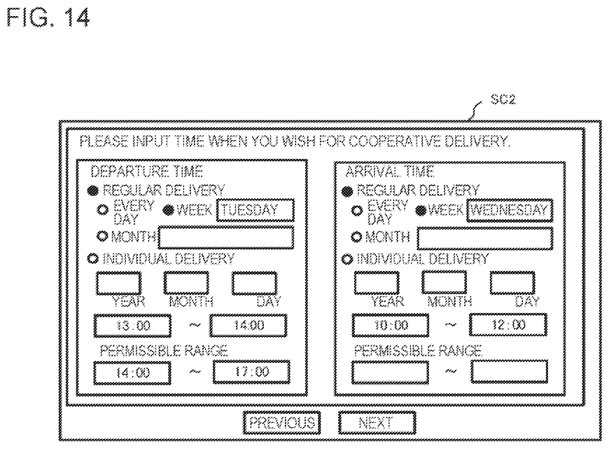

Specifically, for example, the input unit 103 accepts delivery time information of the first package according to a content input to a delivery time input screen SC2 displayed on the display unit 104. FIG. 14 is a diagram illustrating one example of the delivery time input screen SC2.

When a previously determined operation (e.g., pressing of a “next” button illustrated in FIG. 14) is performed, the input unit 103 accepts and holds the departure time and the arrival time input to the delivery time input screen SC2, and executes subsequent processing. Note that, when a “previous” button illustrated in FIG. 14 is pressed, immediately preceding processing (i.e., the processing of step S201) is performed again.

In the example illustrated in FIG. 14, a delivery time for regular delivery with a departure time of 13:00 to 14:00 every Tuesday and an arrival time of from 10:00 to 12:00 every Wednesday is input. Moreover, in the example illustrated in FIGS. 14, 14:00 to 17:00 is input as an allowable time regarding the departure time, and no allowable time is input regarding the arrival time.

Such an example illustrated in FIG. 14 means that, in such a case that the first shipper wishes to depart at 13:00 to 14:00 every Tuesday, but, for example, there is no package to be targeted for cooperative delivery in the time period, a change of a departure time is allowed between 14:00 to 17:00. Moreover, the example illustrated in FIG. 14 means that the first shipper does not allow a change of an arrival time.

The input unit 103 included in the terminal apparatus 101 of the first shipper accepts package property information and fare information relating to the first package according to input of the first shipper (step S203).

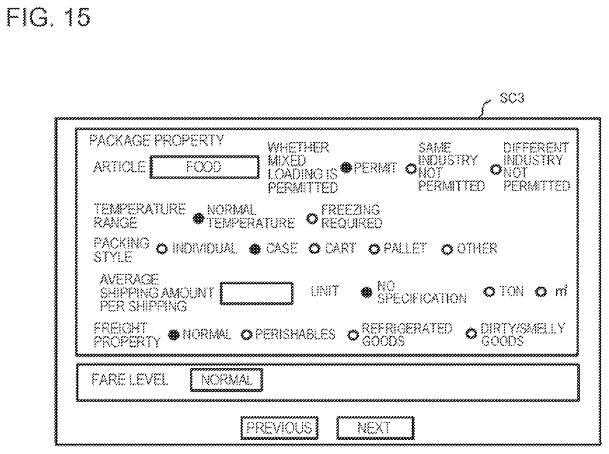

Specifically, for example, the input unit 103 accepts package property information and fare information of the first package according to a content input to an input screen SC3 of the package property information and the fare information displayed on the display unit 104. FIG. 15 is a diagram illustrating one example of an input screen SC3 of the package property information and the fare information.

When a previously determined operation (e.g., pressing of a “next” button illustrated in FIG. 15) is performed, the input unit 103 accepts and holds a content of each item input to the input screen SC3 of the package property information and the fare information, and executes subsequent processing. Note that, when a “previous” button illustrated in FIG. 15 is pressed, immediately preceding processing (i.e., the processing of step S202) is performed again.

In the example illustrated in FIG. 15, regarding each of an article, whether mixed loading is permitted, a temperature range, a packing style, an average shipping amount per shipping, and a freight property that are items of the package property information, “food”, “mixed loading permitted”, “normal”, “case”, “no specification”, and “normal” are input. Moreover, regarding the fare information, a fare level of “normal” is input.

The input unit 103 included in the terminal apparatus 101 of the first shipper accepts fluctuation information and vehicle property information relating to the first package according to input of the first shipper (step S204).

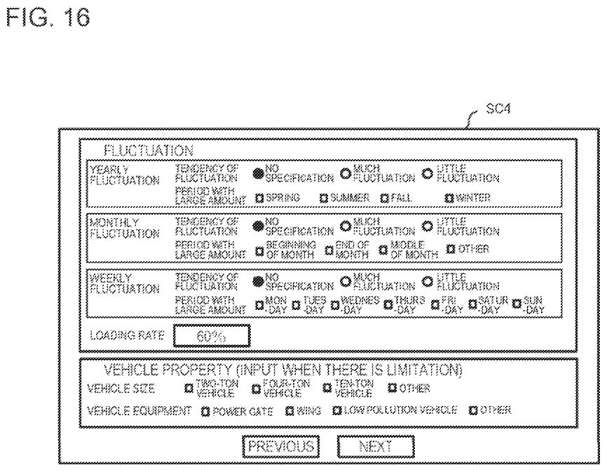

Specifically, for example, the input unit 103 accepts fluctuation information and vehicle property information of the first package according to a content input to an input screen SC4 for the fluctuation information and the vehicle property information displayed on the display unit 104. FIG. 16 is a diagram illustrating one example of an input screen SC4 of fluctuation information and vehicle property information.

When a previously determined operation (e.g., pressing of a “next” button illustrated in FIG. 16) is performed, the input unit 103 accepts and holds a content of each item input to the input screen SC4 of the fluctuation information and the vehicle property information, and returns to cooperative delivery assistance processing illustrated in FIG. 9. Note that, when a “previous” button illustrated in FIG. 16 is pressed, immediately preceding processing (i.e., the processing of step S203) is performed again.

In the example illustrated in FIG. 16, none of yearly, monthly, and weekly fluctuations are specified, and “60%” is input for a load factor. This means that an average load factor is around 60%. Moreover, in the example illustrated in FIG. 16, a vehicle property is not specified either.

Note that, in the delivery condition input processing according to the present example embodiment, an example in which package property information and fare information are collectively accepted, and fluctuation information and vehicle property information are collectively accepted has been described. However, information to be included in a delivery condition is not limited thereto, and may be accepted in an appropriate unit, and an input screen may also be changed as appropriate.

FIG. 9 is referred to again.

The communication unit 105 included in the terminal apparatus 101 of the first shipper transmits a delivery condition accepted in step S101 to the cooperative delivery assistance apparatus 102 (step S102). The delivery condition acquisition unit 106 acquires the delivery condition transmitted in step S102 by receiving the delivery condition via the network N (step S103).

The candidate extraction unit 110 extracts a candidate package from among packages of another shipper, by using a delivery condition acquired in step S103 (step S104).

Specifically, for example, the candidate extraction unit 110 extracts the delivery information 107a of the another shipper stored in the delivery storage unit 107. That is to say, the candidate extraction unit 110 extracts the delivery information 107a including a shipper ID different from a shipper ID of the first shipper.

Then, the candidate extraction unit 110 extracts a candidate package from the delivery information 107a of the another shipper, based on the delivery condition and the extraction rule acquired in step S103.

For example, when the extraction rule includes “allowing mixed loading of a package”, a candidate package for which a condition relating to “whether mixed loading is permitted” fits in a delivery condition and the delivery information 107a of the another shipper is extracted.

Further, for example, when the delivery condition is “mixed loading permitted” indicating that mixed loading with another package is unconditionally permitted, the candidate extraction unit 110 extracts the delivery information 107a of the another package in which “whether mixed loading is permitted” is “mixed loading permitted”.

Moreover, the candidate extraction unit 110 determines types of businesses of the first shipper and the another shipper by an article of the delivery condition. Herein, it is preferable that a rule for determining a business type from an article is previously determined and held in the candidate extraction unit 110. For the another shipper in the same industry as the first shipper, the candidate extraction unit 110 further extracts the delivery information 107a of the another shipper in which “mixed loading permitted” of the delivery information 107a is “different industry not permitted”. Regarding another shipper in a different industry from the first shipper, the candidate extraction unit 110 further extracts the delivery information 107a of the another shipper in which “whether mixed loading is permitted” of the delivery information 107a is “same industry not permitted”.

The fitting degree acquisition unit 112 acquires a fitting degree between the delivery condition acquired in step S103 and the delivery condition of the candidate package extracted in step S104 (step S104).

Specifically, for example, the fitting degree acquisition unit 112 derives a fitting degree by applying a fitting rule to the delivery condition acquired in step S103 and the delivery condition of the candidate package extracted in step S104. For example, since the fitting rule determines an item fitting degree for each item as described above, the fitting degree acquisition unit 112 refers to a content of each item in the delivery condition of the first package and the delivery condition of the candidate package, and derives an item fitting degree of each item according to the fitting rule. The fitting degree acquisition unit 112 acquires a fitting degree by deriving a total of item fitting degrees.

The effect estimation unit 114 estimates a reduction effect regarding a previously determined reduction item, based on a delivery condition acquired in step S103 and a delivery condition of the candidate package extracted in step S104 (step S106).

A reduction effect is derived for each combination of the first package and each of candidate packages. For example, a reduction effect of a fare is derived by a balance acquired by subtracting a fare when the first package and the candidate package are cooperatively delivered from a fare when the first package and the candidate package are individually delivered. Moreover, for example, a reduction effect of an environmental burden can be derived by an amount acquired by subtracting an estimate emission amount of carbon dioxide when the first package and the candidate package are cooperatively delivered from an estimate emission amount of carbon dioxide when the first package and the candidate package are individually delivered. For a unit of expressing a difference of an estimate emission amount of carbon dioxide, an appropriate unit such as carbon dioxide conversion or carbon conversion may be adopted.

The display control unit 115 transmits, to the terminal apparatus 101 of the first shipper, display information including the delivery information 107a of the candidate package extracted in step S104, the fitting degree acquired in step S105, and the reduction effect estimated in step S106 (step S107).

In the display information, it is preferable that the delivery information 107a, the fitting degree, and the reduction effect are associated with each other for each candidate package extracted in step S104.

The communication unit 105 included in the terminal apparatus 101 of the first shipper acquires the display information transmitted in step S107 by receiving the display information via the network N (step S108).

The display unit 104 included in the terminal apparatus 101 of the first shipper displays the display information acquired in step S108 (step S109). In this instance, the display unit 104 displays the candidate package included in the display information in such a way that the candidate package can be selected.

Specifically, for example, the display unit 104 displays some or all of pieces of the delivery information 107a of each candidate package included in the display information according to a fitting degree included in the display information (e.g., by arranging in descending order of fitting degrees). When some of pieces of the delivery information 107a are displayed, it is preferable that an item to be targeted for display in the delivery information 107a is previously determined.

Moreover, it is preferable that the delivery information 107a, a fitting degree, a reduction effect are displayed in association with each other for each candidate package.

The input unit 103 included in the terminal apparatus 101 of the first shipper determines whether a delivery condition has been changed according to whether a change of the delivery condition has been accepted (step S110).

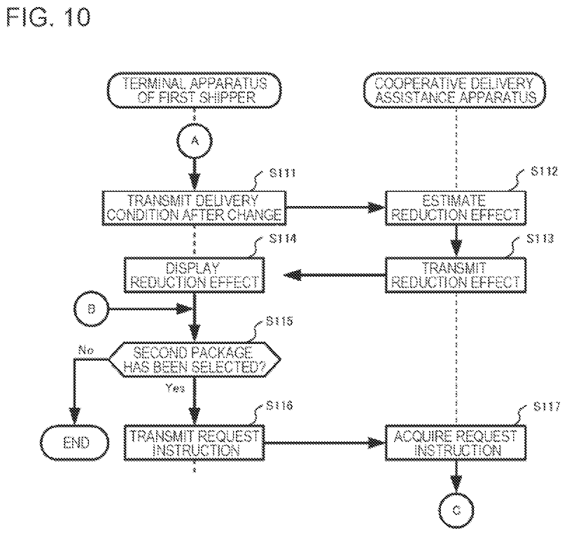

The input unit 103 included in the terminal apparatus 101 of the first shipper determines that the change of the delivery condition has been accepted when the change of the delivery condition has been accepted (step S110; Yes). In this case, as illustrated in FIG. 10, the communication unit 105 included in the terminal apparatus 101 of the first shipper transmits a delivery condition after the change to the cooperative delivery assistance apparatus 102 (step S111).

The effect estimation unit 114 acquires the delivery condition after the change transmitted in step S111, by receiving the delivery condition via the network N. Then, the effect estimation unit 114 estimates a reduction effect regarding a previously determined reduction item by a method similar to that in step S106, based on each of the acquired delivery condition after the change and the delivery condition of the candidate package extracted in step S104 (step S112).

The reduction effect estimated in step S112 is a reduction effect acquired by cooperatively delivering with each of the candidate packages when the first package is delivered under the delivery condition after the change accepted in step S110. That is to say, in step S112, a reduction effect is acquired for each candidate package.

The effect estimation unit 114 transmits, to the terminal apparatus 101 of the first shipper, information including the reduction effect estimated in step S112 (step S113). The communication unit 105 included in the terminal apparatus 101 of the first shipper acquires the information transmitted in step S113 by receiving the information via the network N, and the display unit 104 included in the terminal apparatus 101 of the first shipper displays the reduction effect included in the acquired information (step S114).

In step S114, it is preferable that a reduction effect is displayed for each candidate package in association with the delivery information 107a displayed in step S109. Thereby, the first shipper can refer to a result of simulating how a reduction effect changes, when a delivery condition input in step S101 is changed.

When it is determined that the input unit 103 included in the terminal apparatus 101 of the first shipper has not accepted a change of a delivery condition (step S110; No), or after the processing in step S114, processing in step S115 is performed.

In step S115, the input unit 103 included in the terminal apparatus 101 of the first shipper determines whether the second package is selected, according to whether input for selecting the second package being one of candidate packages has been accepted (step S115).

When a previously determined end operation is performed without selecting the second package, the input unit 103 determines that the second package is not selected (step S115; No), and ends the cooperative delivery assistance processing.

When input for selecting the second package is accepted, the input unit 103 included in the terminal apparatus 101 of the first shipper determines that the second package has been selected (step S115; Yes). In this case, the communication unit 105 included in the terminal apparatus 101 of the first shipper transmits, to the cooperative delivery assistance apparatus 102, a request instruction including second package information for determining the selected second package (step S116).

The second package information includes, for example, a delivery ID of the delivery information 107a related to the second package. For cooperative delivery, it is normally necessary to acquire approval of the second shipper, being a shipper of the second package to be targeted. The request instruction is an instruction to make a request to the second shipper for acquiring the approval.

The request unit 116 acquires the request instruction transmitted in step S116 by receiving the request instruction via the network N (step S117).

FIG. 12 is referred to.

The request unit 116 transmits a request for cooperative delivery to the terminal apparatus 101 of the second shipper according to the request instruction acquired in step S117 (step S118).

Specifically, for example, the request unit 116 determines a shipper ID being associated with a delivery ID included in the request instruction in the delivery information 107a. Then, the request unit 116 transmits a request for cooperative delivery, to a contact point indicated by contact point information being associated with the determined shipper ID in the shipper information 108a.

The communication unit 105 included in the terminal apparatus 101 of the second shipper acquires the request transmitted in step S118 by receiving the request via the network N (step S119).

For example, the request acquired in step S119 is referred to by the second shipper by display or the like on the display unit 104 included in the terminal apparatus 101 of the second shipper. Then, a response to the request is prepared based on the input to the input unit 103 included in the terminal apparatus 101 of the second shipper. The communication unit 105 included in the terminal apparatus 101 of the second shipper transmits, to the cooperative delivery assistance apparatus 102, a response to the request acquired in step S119 (step S120).

The response acquisition unit 117 acquires the response to the request acquired in step S119 by receiving the response via the network N (step S121).

The delivery processing unit 118 notifies the first shipper of the response acquired in step S121 (step S122).

Specifically, for example, the delivery processing unit 118 transmits a content of the response to the contact point indicated by the contact point information being associated with the shipper ID of the first shipper in the shipper information 108a.

The communication unit 105 included in the terminal apparatus 101 of the first shipper acquires the response notification transmitted in step S122 by receiving the response notification via the network N (step S123. Thereby, by display or the like of the content of the response notification on the display unit 104 included in the second shipper, the first shipper can find out whether cooperative delivery with the second package has been approved by the second shipper.

Moreover, after the processing in step S122, the delivery processing unit 118 determines whether the response acquired in step S121 includes the approval of the second shipper (step S124).

Specifically, for example, it is preferable that a response includes, in a previously determined format, information indicating whether the second shipper approves cooperative delivery with the first package. Thereby, the delivery processing unit 118 can determine, by referring to the response, whether the response includes approval of the second shipper.

When it is determined that the response does not include approval of the second shipper (i.e., not approved) (step S124; No), the delivery processing unit 118 ends the cooperative delivery assistance processing.

When it is determined that the response includes approval of the second shipper (step S124; No), the delivery processing unit 118 executes a previously determined cooperative delivery processing (step S125), and ends the cooperative delivery assistance processing.

So far, one example embodiment of the present invention has been described.

According to the present example embodiment, the cooperative delivery assistance apparatus 102 extracts, as a candidate package, a package to be delivered cooperatively with the first package, from among packages of another shipper, by using the delivery condition of the first package acquired from the first shipper. Then, the cooperative delivery assistance apparatus 102 transmits information for displaying the candidate package in a selectable way.

Thereby, the first shipper can refer to a candidate package that fits to a delivery condition of the first package, and select a package to be targeted for selective cooperative delivery from among the candidate packages. Therefore, the cooperative delivery of a package being desirable for the first shipper becomes possible.

According to the present example embodiment, a shipper of the second package being a package selected from among candidate packages is notified of a request for cooperative delivery, and, when approval of the request is acquired, processing for cooperatively delivering the first package and the second package is performed.

Thereby, a wish of a shipper of the second package to be targeted for cooperative delivery can also be met. Therefore, cooperative delivery of a packages beam desirable also for the second shipper becomes possible.

According to the present example embodiment, a candidate package is displayed in a selectable way according to a fitting degree between a delivery condition of the first package and a delivery condition of a candidate package. Thereby, the first shipper can easily refer to and select a candidate package being suitable for cooperative delivery with the first package. Therefore, it becomes possible to facilitate cooperative delivery of a package being desirable for the first shipper.

According to the present example embodiment, a delivery condition includes fluctuation information indicating a periodic fluctuation in a shipping amount of a package. Moreover, a delivery condition also includes a departure area relating to an area of loading a package, and an arrival area relating to an area of unloading the package. Further, the delivery condition further includes departure time information relating to a scheduled time of loading a package, and arrival time information relating to a scheduled time of unloading the package.

In this way, a delivery condition includes various items, and thereby, a candidate package can be extracted or a fitting degree of a candidate package can be derived based on an extraction rule or a fitting rule relating to the various items. Thus, the first shipper can easily refer to and select a candidate package being desirable for cooperative delivery with the first package. Therefore, it becomes possible to facilitate cooperative delivery of a package being even more desirable for the first shipper.

According to the present example embodiment, a delivery condition further includes information indicating a changeable time period (allowable time) for one or both of the departure time information and arrival time information. Thereby, packages to be targeted for cooperative delivery can be combined under a delivery condition in which a condition is relaxed for one or both of a departure time and an arrival time, and, therefore, the first shipper can increase options of packages to be targeted for cooperative delivery. Moreover, since an allowable time is set by a shipper, and is therefore desirable for the shipper. Therefore, it becomes possible to further facilitate cooperative delivery of a package being desirable for the first shipper.

According to the present example embodiment, a departure area and an arrival area include an area of each previously determined hierarchical layer with a hierarchical structure.

In this way, an area is defined with a hierarchical structure, and, thereby, a candidate package can be extracted or a fitting degree of a candidate package can be derived based on an extraction rule or a fitting rule considering a degree at which an area matches.

As one example of the aspect, an example in which, when at least one of an area of a hierarchical layer of the highest order included in the departure area and an area of a hierarchical layer of the highest order included in arrival area information is common to the first package and a package of another shipper, the package of the another shipper is extracted as a candidate package can be cited.

Thereby, the first shipper can easily refer to and select a candidate package being desirable for cooperative delivery with the first package. Therefore, it becomes possible to facilitate cooperative delivery of a package being even more desirable for the first shipper.

According to the present example embodiment, information for displaying a degree at which a previously determined reduction item can be reduced in a case where the first package and the candidate package are cooperatively delivered as compared to a case where the first package and the candidate package are individually delivered is transmitted.

Thereby, the first shipper can also refer to the reduction effect and select a package being suitable for cooperative delivery with the first package. Therefore, cooperative delivery of a package being even more desirable for the first shipper becomes possible.

According to the present example embodiment, the terminal apparatus 101 acquires information including a candidate package in which a package to be delivered cooperatively with the first package is extracted as the candidate package from among packages of another shipper, by using a delivery condition of the first package accepted by input of the first shipper. Then, the terminal apparatus 101 displays, in a selectable way, a candidate package included in the acquired information.

Thereby, the first shipper can refer to the candidate package that fits to a delivery condition of the first package, and select a package to be targeted for selective cooperative delivery from among the candidate packages. Therefore, cooperative delivery of a package being desirable for the first shipper becomes possible.

In the above, one example embodiment of the present invention has been described with reference to the drawings, and a modified example thereof has been described as an explanatory note. However, the embodiment and the modified example are exemplifications of the present invention, and various configurations other than the above can also be adopted.

For example, an area belonging to each hierarchical layer may be determined appropriately without being associated with prefectures, municipalities, or the like, and the number of hierarchical layers when an area is defined with a hierarchical structure may be equal to or more than three.

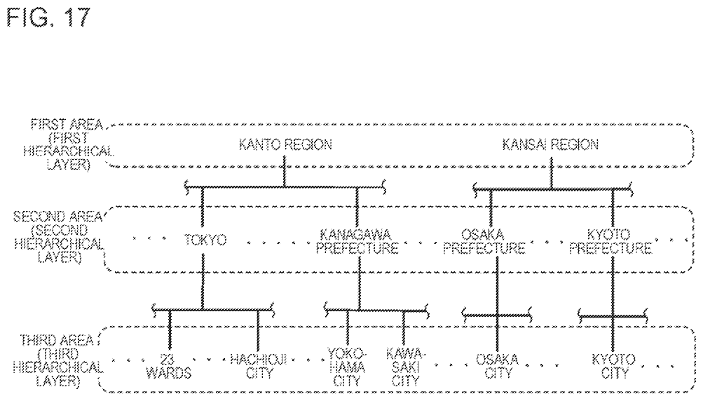

FIG. 17 is a diagram illustrating an example in which an area is defined by a three-layer hierarchical structure. In this case, as illustrated in the figure, it is preferable that an area being associated with one or a plurality of previously determined prefectures (so-called Kanto region, Tokai region, or the like) is defined as a first area belonging to a first hierarchical of the highest order. It is preferable that prefectures are defined as a second area belonging to the second hierarchical layer being in a low order of the first hierarchical layer. It is preferable that an area being associated with one or a plurality of previously determined municipalities is set as a third area belonging to a third hierarchical layer being in a low order of the second hierarchical layer.

Then, it is preferable that such a hierarchical structure that a second area geographically included in a first area belongs to a low order of the first area, and a third area geographically included in the second area belongs to the low order of the second area is defined.

Further, for example, although a plurality of processes (pieces of processing) are described in order in a diagram illustrating a flow used in the above description, an execution order of the processes is not limited to the described order. An order of the processes may be changed to an extent that causes no problem in terms of content. Moreover, the one example embodiment and modified example described above may be combined to an extent that content does not contradict.

One means or all means according to the example embodiment described above can also be described as, but are not limited to, the following supplementary notes.
1. A cooperative delivery assistance apparatus including:
   a delivery condition acquisition unit that acquires a delivery condition of a first package from a first shipper;
   a candidate extraction unit that extracts, as a candidate package, a candidate of a package to be delivered cooperatively with the first package, from among packages of another shipper, by using the acquired delivery condition; and
   a display control unit that transmits information for displaying the extracted candidate package in a selectable way.
2. The cooperative delivery assistance apparatus according to supplementary note 1, further including:
   a request unit that notifies, of a request for cooperative delivery, a shipper of a second package being a package selected from among the displayed candidate packages; and
   a delivery processing unit that performs processing for cooperatively delivering the first package and the second package when approval for the request is acquired.
3. The cooperative delivery assistance apparatus according to supplementary note 1 or 2, further including
   a fitting degree acquisition unit that derives a fitting degree between the acquired delivery condition and a delivery condition of the candidate package, wherein
   the display control unit displays the extracted candidate package in a selectable way according to the acquired fitting degree.
4. The cooperative delivery assistance apparatus according to any one of supplementary notes 1 to 3, wherein
   the delivery condition includes fluctuation information indicating a periodic fluctuation in a shipping amount of a package.
5. The cooperative delivery assistance apparatus according to any one of supplementary notes 1 to 4, wherein
   the delivery condition includes a departure area relating to an area of loading the package, and an arrival area relating to an area of unloading the package.
6. The cooperative delivery assistance apparatus according to supplementary note 5, wherein
   the delivery condition further includes departure time information relating to a scheduled time of loading the package, and arrival time information relating to a scheduled time of unloading the package.
7. The cooperative delivery assistance apparatus according to supplementary note 6, wherein
   the delivery condition further includes information indicating a changeable time period for one or both of the departure time information and the arrival time information.
8. The cooperative delivery assistance apparatus according to any one of supplementary notes 5 to 7, wherein
   the departure area and the arrival area include an area of each previously determined hierarchical layer with a hierarchical structure.
9. The cooperative delivery assistance apparatus according to supplementary note 8, wherein,
   when at least one of an area of a hierarchical layer of the highest order included in the departure area and an area of a hierarchical layer of the highest order included in the arrival area information is common to the first package and a package of the another shipper, the candidate extraction unit extracts a package of the another shipper as the candidate package.
10. The cooperative delivery assistance apparatus according to any one of supplementary notes 1 to 9, wherein
   the display control unit transmits information for displaying a degree at which a previously determined reduction item can be reduced in a case where the first package and the candidate package are cooperatively delivered as compared to a case where the first package and the candidate package are individually delivered.
11. A cooperative delivery assistance system including:
   a delivery condition acquisition unit that acquires a delivery condition of a first package from a first shipper;
   a candidate extraction unit that extracts, as a candidate package, a candidate of a package to be delivered cooperatively with the first package, from among packages of another shipper, by using the acquired delivery condition; and
   a display unit that displays the extracted candidate package in a selectable way.
12. A terminal apparatus including:
   an input unit that accepts input of a delivery condition of a first package from a first shipper;
   a communication unit that acquires a candidate package acquired by extracting, as the candidate package, a candidate of a package to be delivered cooperatively with the first package, from among packages of another shipper, by using the accepted delivery condition; and
   a display unit that displays the acquired candidate package in a selectable way.
13. A cooperative delivery assistance method including,
   by a computer:
   acquiring a delivery condition of a first package from a first shipper;
   extracting, as a candidate package, a candidate of a package to be delivered cooperatively with the first package, from among packages of another shipper, by using the acquired delivery condition; and
   transmitting information for displaying the extracted candidate package in a selectable way.
14. A program causing a computer to execute:
   acquiring a delivery condition of a first package from a first shipper;
   extracting, as a candidate package, a candidate of a package to be delivered cooperatively with the first package, from among packages of another shipper, by using the acquired delivery condition; and
   transmitting information for displaying the extracted candidate package in a selectable way.

### REFERENCE SIGNS LIST

100 Cooperative delivery assistance system
101 Terminal apparatus
102 Cooperative delivery assistance apparatus
103 Input unit
104 Display unit
105 Communication unit
106 Delivery condition acquisition unit
107 Delivery storage unit
107a Delivery information
108 Shipper storage unit
108a Shipper information
109 Transporter storage unit
109a Transporter information
110 Candidate extraction unit
111 Extraction rule storage unit
112 Fitting degree acquisition unit
113 Fitting rule storage unit
114 Effect estimation unit
115 Display control unit
116 Request unit
117 Response acquisition unit
118 Delivery processing unit

What is claimed is:

1. A cooperative delivery assistance apparatus comprising:
at least one memory configured to store instructions; and
at least one processor configured to execute the instructions to:
acquire a delivery condition of a first package from a first shipper;
extract, as a candidate package, a candidate of a package to be delivered cooperatively with the first package, from among packages of another shipper, by using the acquired delivery condition; and
transmit information for displaying the extracted candidate package in a selectable way.

2. The cooperative delivery assistance apparatus according to claim 1, wherein the at least one processor is further configured to execute the instructions to:
notify, of a request for cooperative delivery, a shipper of a second package being a package selected from among the displayed candidate packages; and
perform processing for cooperatively delivering the first package and the second package when approval for the request is acquired.

3. The cooperative delivery assistance apparatus according to claim 1, wherein the at least one processor is further configured to execute the instructions to:
derive a fitting degree between the acquired delivery condition and a delivery condition of the candidate package, wherein
the transmitted information is information for displaying the extracted candidate package in the selectable way according to the acquired fitting degree.

4. The cooperative delivery assistance apparatus according to claim 1, wherein
the delivery condition includes fluctuation information indicating a periodic fluctuation in a shipping amount of a package.

5. The cooperative delivery assistance apparatus according to claim 1, wherein
the delivery condition includes a departure area relating to an area of loading the package, and an arrival area relating to an area of unloading the package.

6. The cooperative delivery assistance apparatus according to claim 5, wherein
the delivery condition further includes departure time information relating to a scheduled time of loading the package, and arrival time information relating to a scheduled time of unloading the package.

7. The cooperative delivery assistance apparatus according to claim 6, wherein
the delivery condition further includes information indicating a changeable time period for one or both of the departure time information and the arrival time information.

8. The cooperative delivery assistance apparatus according to claim 5, wherein
the departure area and the arrival area include an area of each previously determined hierarchical layer with a hierarchical structure.

9. The cooperative delivery assistance apparatus according to claim 8, wherein,
when at least one of an area of a hierarchical layer of a highest order included in the departure area and an area of a hierarchical layer of the highest order included in the arrival area information is common to the first package and a package of the another shipper, the package of the another shipper is extracted as the candidate package.

10. The cooperative delivery assistance apparatus according to claim 1, wherein
the transmitted information includes information for displaying a degree at which a previously determined reduction item can be reduced in a case where the first package and the candidate package are cooperatively delivered as compared to in a case where the first package and the candidate package are individually delivered.

11.-12. (canceled)

13. A cooperative delivery assistance method comprising,
by at least one computer:
acquiring a delivery condition of a first package from a first shipper;
extracting, as a candidate package, a candidate of a package to be delivered cooperatively with the first package, from among packages of another shipper, by using the acquired delivery condition; and
transmitting information for displaying the extracted candidate package in a selectable way.

14. A non-transitory storage medium storing a program causing at least one computer to execute:
acquiring a delivery condition of a first package from a first shipper;
extracting, as a candidate package, a candidate of a package to be delivered cooperatively with the first package, from among packages of another shipper, by using the acquired delivery condition; and
transmitting information for displaying the extracted candidate package in a selectable way.
